(19) United States
(12) Patent Application Publication
(10) Pub. No.: US 2015/0012349 A1
(43) Pub. Date: Jan. 8, 2015

(54) REACTIVE SEGMENTING SYSTEM AND ASSOCIATED METHODS

(71) Applicant: CONTECH HOLDINGS, LLC, Winterpark, FL (US)

(72) Inventors: Michael Connolly, Winterpark, FL (US); Nathaniel Thomas, Winterpark, FL (US)

(73) Assignee: CONTECH HOLDINGS,LLC, Winterpark, FL (US)

(21) Appl. No.: 14/498,557

(22) Filed: Sep. 26, 2014

Related U.S. Application Data
(60) Provisional application No. 61/773,184, filed on Mar. 6, 2013.

(51) Int. Cl. G06Q 30/02

(52) U.S. Cl. CPC G06Q 30/0242; G06Q 30/0275
USPC 705/14.41

(57) ABSTRACT

A computer-implemented method for providing decision support for marketing of online advertising includes creating bid records using information parsed from real-time bidding (RTB) event data for a targeted ad impression. The bid records identify a plurality of advertisers defined as a brand, which include both winning and non-winning bidders. The bid records are analyzed to determine a demand from the brand for ad impressions in the publisher inventory other than the targeted ad impression. Demand analysis includes brand metrics segmentation and user-to-segment association of brand metrics, the results of which support direct sale of publisher inventory similar to the targeted ad impression to non-winning bidders.

### RELATED APPLICATIONS

This application claims the benefit under 35 U.S.C. §119(e) of U.S. Provisional Patent Application Ser. No. 61/883,656 filed by the inventors of the present application on Sep. 27, 2013, and titled Reactive Segmenting System And Associated Methods, the entire content of which is incorporated herein by reference except to the extent that disclosure therein is inconsistent with disclosure herein.

### FIELD OF THE INVENTION

The present invention relates to the field of online ad serving and, more specifically, to targeting advertisers in an online real-time bidding market, and associated systems and methods.

### BACKGROUND

Real-time bidding (RTB) is a sales channel in which a publisher of online content, such as a website, may place an ad request to fill available ad space complementary to that content. An ad impression may be defined as a single instance of an ad appearing on a website (i.e., a person sees the advertisement). Multiple advertisers may place auction-style bids on desired ad impressions, with the targeted ad impression going to the highest bidder. Real-time bids submitted by the multiple advertisers are considered not only against one other, but also against any relevant price floor (also called a reserve price) below which a publisher will not sell a particular ad space. The automated processing of these and other conditions precedent to completing the RTB transaction takes place in milliseconds, resulting in ad delivery that appears to a target consumer (e.g., the viewer of the ad) to occur instantaneously.

The real-time bidding sales model has the potential to give publishers access to more advertising demand sources and, consequently, to increase publisher revenue. However, current RTB technology tends to turn away many opportunities to sell to interested advertisers. For example, many RTB auctions are “second price” auctions, which means the winning bidder pays slightly more than the next highest bidder's offer for the targeted ad impression. The offers of all losing bidders are typically rejected without further action. Turning away interested advertisers represents missed opportunities for the publisher to exploit those potential sales leads during and/or after the auction. Similarly, publishers who set price floors too high may turn away interested advertisers at the risk of not finding another buyer later, and therefore potentially may compromise publisher revenue even more.

RTB technology designed for second price auctions is often biased to the interests of advertisers at the expense of publishers. More specifically, not only do second price auctions put downward pressure on pricing, but also advertisers typically have access to decision-support data from completed auctions that publishers do not. Various approaches to allow publishers to access and analyze real-time bidding information exist in the art.

U.S. Patent Application Publication No. 2004/0193488 by Khoo et al. discloses a method and system for statistics-based individualized advertising over a network. Feedback statistics characterizing the actual delivery of an advertisement to a user or group of users may be used to adjust the future delivery price. However, the Khoo implementation does not collect and analyze statistics related to the pre-delivery bidding behavior of interested advertisers whose bids did not win an auction.

U.S. Patent Application Publication No. 2009/0240568 by Ramer et al. discloses aggregating user behavioral data across multiple wireless operators and delivering content to a mobile communication facility based at least in part on that aggregation. However, the Ramer implementation creates and stores behavior data relating not to competing advertisers but instead to mobile communication facility users being targeted by those advertisers.

Real-time bidding automation may present an opportunity for publishers to improve decision support by collecting and analyzing information regarding the bidding behavior of prospective buyers (e.g., advertisers), such as offered bid prices and targeted ad impressions. Specifically, a need exists to capture and analyze historical data gathered during an auction from all bidders (not just winning bidders) for marketing and pricing decision support purposes. There also exists a need to empower a publisher to capture and analyze targeted user information collected during the evaluation of an ad impression by multiple prospective advertisers, including both winning and non-winning bidders. There further exists a need to equip publishers to classify targeted ad impressions into groupings, each of which may be analyzed, valued, and marketed as a whole.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the foregoing in mind, it is therefore an object of the present invention to provide a reactive segmenting system (RSS) to support identification and exploitation of advertisement sales opportunities based on real-time bidding (RTB) metrics captured during an auction. The RSS may advantageously comprise bid aggregation technology to capture bid metrics for both winning and non-winning advertisers (also defined as “brands”) participating in an RTB auction, and to segment these bid metrics into areas of brand interest. The system may analyze these segmented data both to identify advertising customers as marketing targets and to value unique groups of online users as delivery targets.

The present invention may advantageously present to a publisher the brands that are bidding on certain ad impressions the most to help identify revenue opportunities. Furthermore, the present invention may advantageously present to a publisher the brands that are bidding on the highest number of unique users but not winning, in order to help identify revenue opportunities. Also, the present invention advantageously may allow a publisher to set a threshold to determine the importance of targeted user data and to react to marketing opportunities based on an improved understanding of ad impression value.

The present invention may also advantageously allow a publisher to use reactive segmenting of captured bid information to show the potential reach for interested brands and to target marketing to those interested brands to increase overall publisher revenue. The RSS also may advantageously be used to pre-value a user segment and to suggest a price for an ad impression and/or equip a publisher to make price floor decisions that cause the real-time bidding process to generate more accurate bids against ad impressions.

These and other objects, features, and advantages according to the present invention are provided by a computer system defining a reactive segmenting system for providing decision support for marketing of online advertising. The system may include a publisher server that may be configured to retrieve, from an ad network, bid information comprising real-time bidding (RTB) event data for a targeted ad impression. The targeted ad impression may be one of a plurality of ad impressions defining a publisher inventory. The publisher server may also be configured to create, using the bid information, a plurality of bid records each comprising an ad impression identifier, a bid price, and a bidder identifier. The bidder identifiers in the plurality of bid records may collectively identify a plurality of advertisers defined as a brand. The plurality of advertisers included in the brand may include a winning bidder and a non-winning bidder. The publisher server may further be configured to analyze the plurality of bid records to determine a demand from the brand for the publisher inventory other than the targeted ad impression.

The publisher server may also be configured to analyze the plurality of bid records by determining a targeted user of interest to a brand segment selected from the group consisting of the winning bidder, the non-winning bidder, and the plurality of advertisers included in the brand, and by associating the targeted user to the brand segment. The publisher server may further be configured to analyze the plurality of bid records by determining an inventory segment for the targeted ad impression. The inventory segment may be selected from the group consisting of network inventory, publisher inventory, domain inventory, and single placement inventory. The plurality of bid records may be further analyzed by associating the targeted user with the inventory segment.

The publisher server may still further be configured to analyze the plurality of bid records by determining a bid factor for the targeted ad impression. The bid factor may be selected from the group consisting of an average price floor, a price floor increment, and a bid block condition. The plurality of bid records may also be analyzed by associating the targeted user to the bid factor. The publisher server may also be configured to analyze the plurality of bid records by determining at least one bid price for the targeted ad impression received from one or more of the winning bidder, the non-winning bidder, and the brand.

The publisher server may be further configured to analyze the plurality of bid records by determining at least one count of bids received for the targeted ad impression from one or more of the winning bidder, the non-winning bidder, and the brand. The publisher server may be still further configured to analyze the plurality of bid records by determining an inventory segment for the targeted ad impression. The inventory segment may be selected from the group consisting of network inventory, publisher inventory, domain inventory, and single placement inventory. The plurality of bid records may also be analyzed by associating the at least one count of bids with the inventory segment.

The publisher server may also be configured to analyze the plurality of bid records by determining for the inventory segment at least one count of bids received for the targeted ad impression. The at least one count of bids may be received from one or more of the winning bidder, the non-winning bidder, and the brand. The publisher server may further be configured to identify a marketing target based on the demand from the brand. The publisher server may be still further configured to set at least one of a price and a price floor for one of the publisher inventory other than the targeted ad impression based on the demand from the brand.

A method aspect of the present invention is for reactive segmenting for providing decision support for marketing of online advertising. The computer implemented method may include receiving bid information comprising real-time bidding (RTB) event data for a targeted ad impression. The targeted ad impression may be provided by one of a plurality of ad impressions defining a publisher inventory. The method may also include creating, using the bid information, a plurality of bid records each comprising an ad impression identifier, a bid price, and a bidder identifier. The bidder identifiers in the plurality of bid records may collectively identify a plurality of advertisers defined as a brand, and the plurality of advertisers may include a winning bidder and a non-winning bidder. The computer implemented method may further include analyzing the plurality of bid records to determine a demand from the brand for the publisher inventory other than the targeted ad impression.

### BRIEF DESCRIPTION OF THE DRAWINGS

FIG. 1 is a schematic block diagram of a computer system defining a reactive segmenting system according to an embodiment of the present invention.

FIG. 2 is a flowchart illustrating a reactive segmenting process as used in connection with a reactive segmenting system according to an embodiment of the present invention.

FIG. 3 is a diagram illustrating an exemplary data structure as used in connection with the reactive segmenting process depicted in FIG. 2.

FIG. 4 is a flowchart illustrating a brand metric collection process as used in connection with a reactive segmenting system according to an embodiment of the present invention.

FIG. 5 is a flowchart illustrating a brand metrics segmentation process as used in connection with a reactive segmenting system according to an embodiment of the present invention.

FIGS. 6A and 6B are flowcharts illustrating a user association process as used in connection with a reactive segmenting system according to an embodiment of the present invention.

FIG. 7 is a diagram illustrating an exemplary system interface for presenting segmented data to a publisher as used in connection with a reactive segmenting system according to an embodiment of the present invention.

FIG. 8 is a diagram illustrating an exemplary system interface for presenting segmented data to an advertiser as used in connection with a reactive segmenting system according to an embodiment of the present invention.

FIGS. 9A and 9B are diagrams illustrating exemplary system interfaces supporting negotiation between a publisher and an advertiser as used in connection with a reactive segmenting system according to an embodiment of the present invention.

FIG. 10 is a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art will realize that the following embodiments of the present invention are only illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Example methods and systems for reactive segmenting of RTB auction bidding information are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation.

Some of the illustrative aspects of the present invention may be advantageous in solving the problems herein described and other problems not discussed which are discoverable by a skilled artisan.

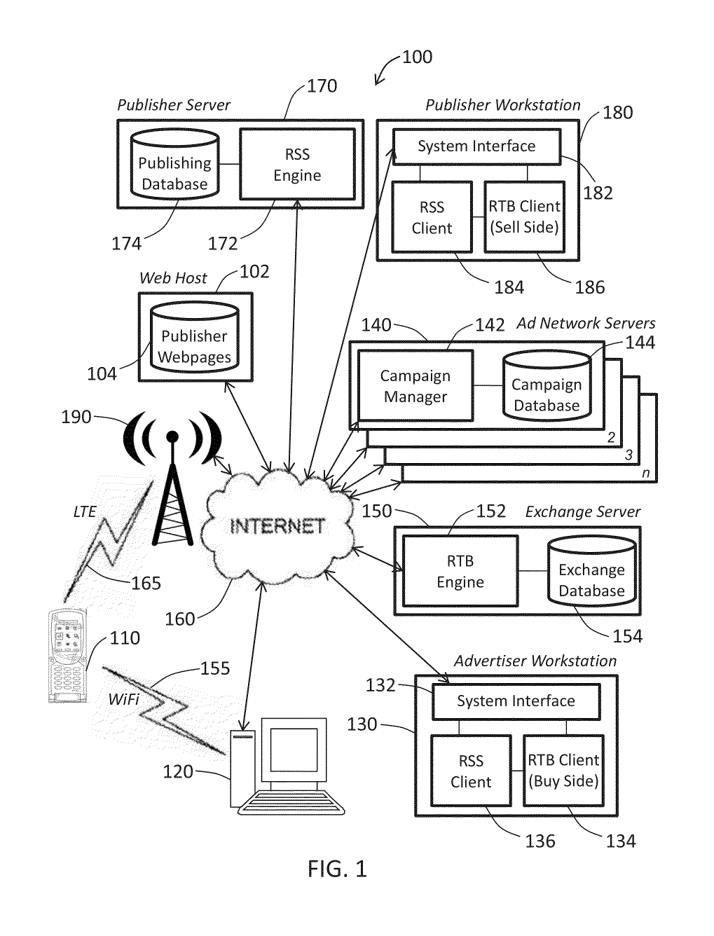

Referring now to FIGS. 1-10, systems and methods for reactively segmenting bid information in a real-time bidding scenario according to an embodiment of the present invention are now described in greater detail. Throughout this disclosure, the present invention may be referred to as a reactive segmenting system, an RSS, a computer program product, a computer system, a computer program, a product, a system, a tool, and a method. Those skilled in the art will appreciate that this terminology does not affect the scope of the invention as outlined herein.

In the following disclosure, the present invention may be referred to as relating to adverts, advertisements, marketing campaigns, unsolicited content, and ads. Those skilled in the art will appreciate that this terminology is only illustrative and does not affect the scope of the invention. For instance, the present invention may just as easily relate to electronic coupons, political messages, public service announcements, or informational broadcasts.

Referring initially to FIG. 1, a real-time bidding (RTB) environment may be employed to deliver and display paid advertisements when a user of a computerized device navigates electronically to a publisher's website. A publisher may employ a web host 102 to store web pages 104 comprising the publisher's website that is viewed by the visiting user. The data store holding the publisher web pages 104 may include digital information in the form of primary content (e.g., the publisher's website) and also of complementary content, such as advertisements, pictures, figures, text, videos, audio recordings or any other digital content. The user's computerized device may be a mobile device 110, such as a cell phone, smart phone, notebook computer, a tablet personal computer (PC), or a personal digital assistant (PDA). Alternatively, the user's computerized device may be a desktop computer 120 or a laptop computer. The RTB environment may further comprise advertiser workstations 130 and ad network servers 140 in data communication with an exchange server 150 via a network 160. A prospective advertiser may use the system interface 132 of the advertiser workstation 130 to access a buy-side RTB client 134. The buy-side RTB client 134 may allow an advertiser to participate in real-time bidding for desired ad impressions to be delivered to a publisher's website 104. More specifically, advertisers may use the real-time bidding (RTB) client 134 to bid on ad space, rather than pay the publisher's set price for the ad space. For example, and without limitation, the bid price for ad space may be expressed as a CPM value (computed as ad revenue per thousand impressions).

The exchange server 150 may comprise a real-time bidding (RTB) engine 152 that may manage calls to one or more ad network servers 140 (also known as Demand Side Platforms or Ad Exchanges) to determine which of several competing advertisers is allowed to serve an ad to a publisher's web page(s) 104. The computer-programmed instructions that may constitute the RTB engine 152 and/or the transaction data manipulated during the RTB process may be stored to and retrieved from an exchange database 154. The exchange server 150 may execute the RTB engine 152 to determine which ad networks may have visibility to a publisher's ad request, and may create an impression request package for each ad network server 140 containing information the ad network server 140 needs to make a bidding decision. For example, and without limitation, a set of attributes associated with each user of a computerized device 110, 120 may be transferred from the exchange server 150 to the ad network server 140.

Ad network servers 140 each may comprise a campaign manager 142 that may manipulate advertising data stored in a campaign database 144. Each ad network server 140 may respond uniquely to individual advertiser ad requests by applying some form of business rule in real-time to decide which campaign to bid with and at what price. For example, the campaign manager 142 may determine whether the user of a computerized device 110, 120 has the desired attributes (recorded, for example, as cookies containing user identification data) that an advertiser desires in a target consumer. Data representing the user's actual attributes and also the advertiser's desired attributes may be stored to and retrieved from the campaign database 144 to support comparison. Based on the perceived marketing value of this user (e.g., a close match of user attributes to desired attributes), competing bids may be placed on this ad impression by relevant advertisers.

The highest bidding advertiser may be allowed by the exchange server 150 to serve the ad placement. More specifically, the RTB engine 152 may route the ad content (also known as the “creative”) to the publisher web pages 102, may inform the ad network server 140 of its winning bid, and may communicate the clearing price for the ad placement to facilitate payment. Alternatively, an ad network server 140 may respond to an ad request with a signal indicating a decision not to bid on that ad impression. The RTB engine 152 may record information regarding winning bids, non-winning bids, and no bids (also referred to as passbacks) for the ad impression and may transmit those bid request data to the impacted publisher.

Continuing to refer to FIG. 1, a reactive segmenting system (RSS) according to an embodiment of the present invention is now described in greater detail. The RSS may include a publisher server 170 and a publisher workstation 180 that may be adapted to be used in connection with the network 160, such as the Internet, to position the publisher server 170 and publisher workstation 180 in data communication with the real-time bidding environment described above. More specifically, the publisher server 170 may comprise an RSS engine 172 and a publishing database 174. For example, and without limitation, the RSS engine 172 may populate the publishing database 174 with bid request data retrieved from the exchange server 150. The publisher workstation 180 may comprise system interface 182 that may access an RSS client application 184 and also a sell-side RTB client application 182. The RSS client application 184 may be in data communication with the publisher server 170 components through the network 160. A person of skill in the art will appreciate that the publisher-controlled components illustrated in FIG. 1 may reside on multiple computing devices (i.e., a publisher server 170, a publisher workstation 180, a web host 102, and/or an exchange server 150) or, alternatively, may be collocated on a single computing device. Also, a person of skill in the art will appreciate that the aforementioned components and computing devices may be provided by a third party as a service to a publisher.

The publisher server 170 and the publisher workstation 180 may be connected to the network 160 via a network server, a network interface device, or any other device capable of making such a data communication connection. Alternatively, or in addition, the publisher server 170 and the publisher workstation 180 may be configured to be connected with the network 160 via a hotspot 120 that, for example, may employ a router connected to a link to a network. For example, and without limitation, the publisher server 170 and the publisher workstation 180 may be connected to the Internet by a wireless fidelity (WiFi) connection 155. The network interface device 120 may be any type of network interface device, including, without limitation, an Ethernet card and a wireless communication device such as an 802.11/WiFi network interface or a Wireless LAN device. The mobile network 190 may be any type of cellular network device, including GSM, GPRS, CDMA, EV-DO, EDGE, 3G, DECT, OFDMA, WIMAX, and LTE communication devices. These and other communication standards permitting connection to a network 160 may be supported within the invention. Moreover, other communication standards connecting the mobile device 110 with an intermediary device that is connected to the Internet, such as USB, FireWire, Thunderbolt, and any other digital communication standard may be supported by the invention.

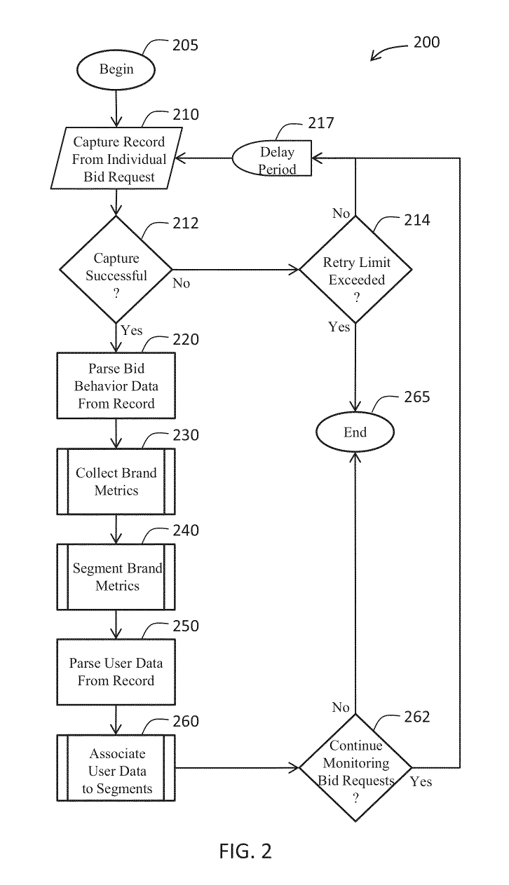

Referring now to flowchart 200 of FIG. 2 and continuing to refer to the block diagram of FIG. 1, the general operation of the RSS will be discussed in greater detail. More specifically, the relationship between the publisher server 170 and the exchange server 150, as well as the operational steps of segmenting and associating data parsed from an individual bid request, will now be discussed.

The following illustrative embodiment is included to provide clarity for one operational method that may be included within the scope of the present invention. A person of skill in the art will appreciate additional databases and operations that may be included within the RSS of the present invention, which are intended to be included herein and without limitation. Also, the general operation illustrated in flowchart 200 describes a method of interaction involving a single exchange server 150. However, this method may be instantiated for any number of exchange servers simultaneously, and in a manner that generates results asynchronously.

From the start, the operation may begin at Block 205 where an auction of a targeted ad impression may be processed by a publisher-accessible exchange server 150 (Block 210). For example, and without limitation, the RSS engine 172 of the publisher server 170 may query the RTB engine 152 for information relating to a bid event (e.g., the auction) involving the ad request. The exchange server 150 may capture bid information such as bidder identifier, targeted impression identifier, and bid price. For example, and without limitation, bid information capture may occur in real time on an impression-by-impression basis. If at Block 212 the retrieval of bid information from the exchange server 150 is successful, then the RSS engine 172 may process the RTB bid data in that bid information (Block 220). For example, and without limitation, those data that are significant to the demonstration of brand interest in a given ad impression (e.g., bidder identifier, targeted impression identifier, and bid price) may be culled from the bid information and used to create bid records. The RSS engine 172 of the publisher server 170 may store each bid record to the publishing database 174. Detection of an unsuccessful attempt to retrieve billing information at Block 212 may result in the RSS attempting the retrieval operation again (Block 214). If the RSS detects that a limit on the number of allowed retries is exceeded at Block 214, then the process 200 may end (Block 265). Otherwise, up to a limited number of retries (Block 214), the RSS engine 172 may enforce a delay period (Block 217) in process 200 before attempting again to retrieve bid information from the exchange server 150 (Block 210). For example, and without limitation, the delay period may be set to the frequency at which the exchange server 150 is monitored so as to give the exchange server 150 time to process a fresh bid information that is readable by the RSS.

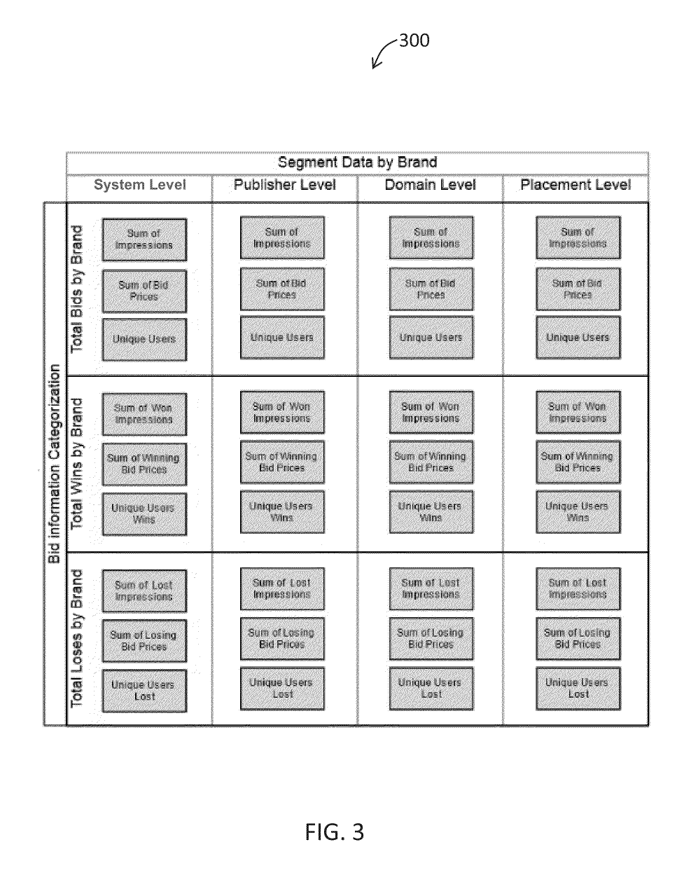

At Block 230, the RSS engine 170 may collect metrics related to the bid event by the brand present in the bid record captured from the exchange server 150. These metrics data may be organized by the RSS engine 170 into segments that may provide insight into brand interests in delivered ad impressions (Block 240). At Block 250, the RSS engine 170 may further parse the individual bid record from the exchange server 150 for user data that may characterize the user targeted for delivery of the subject ad impression. The RSS engine 170 subsequently may associate these user data with some number of brand metric segments. For example, and without limitation, FIG. 3 illustrates an exemplary data structure 300 that may be created and populated with data using process 200 of FIG. 2. The methods of brand metric collection (Block 230), brand metric segmentation (Block 240), and user association to segments (Block 260) each are described in more detail below.

Continuing to refer to FIG. 2 at Block 262, an election to continue monitoring of bid events from the exchange server 150 may cause the RSS engine 172 to enforce a delay period (Block 217) as described above. For example, and without limitation, the monitoring election may be made by the publisher through the system interface 182 to the RSS client 184. Also for example, and without limitation, this election may be accomplished manually for each billing information capture or, alternatively, may recur automatically at a preset interval. An election to cease bid event monitoring at Block 262 may cause the process 200 end at Block 265.

Those of ordinary skill in the art will realize that the above embodiment of the present invention is only illustrative and is not intended to be limiting in any way. Other embodiments of algorithms for parsing bid request information retrieved from any data source including, for example and without limitation, exchange servers 150 and/or ad network servers 140, will readily suggest themselves to such skilled persons having the benefit of this disclosure.

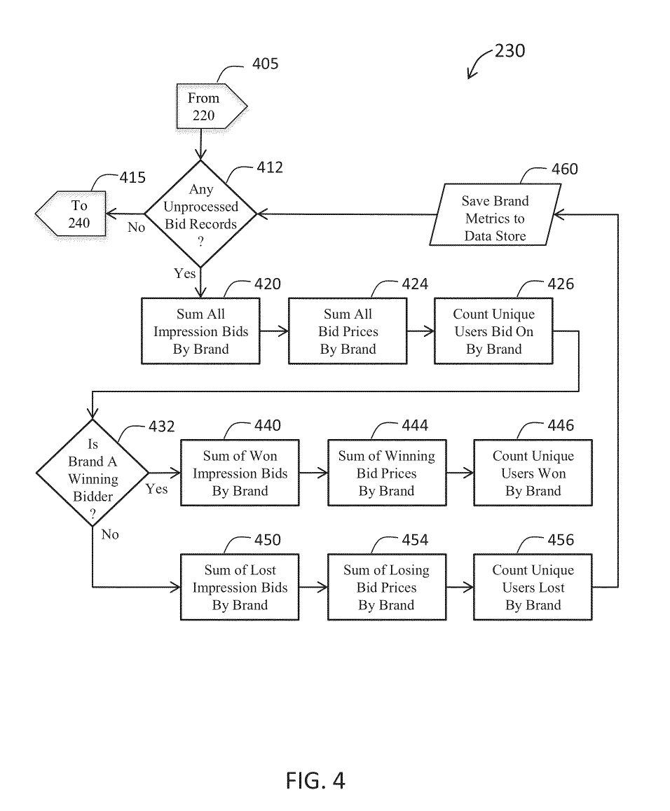

Referring now to flowchart 230 of FIG. 4 and continuing to refer to the block diagram of FIG. 1, the operation of the brand metric collection function of the RSS will be discussed in greater detail.

From the start, the operation may begin at Block 405 where records created from billing information captured from any number of bidding events on the exchange server 150 (as illustrated at Block 220 of FIG. 2) may be parsed to identify the brand for which bidding data may be present in each record. For each bidding event by a brand, a record representing that event may be processed that captures pertinent metrics that may characterize bid behavior (Block 412). For example, and without limitation, the RSS engine 172 may identify and count the ad impression bids made by each brand (Block 420), the bid prices offered by each brand (Block 424), and the unique users bid on by each brand (Block 426). Also for example, and without limitation, for each winning brand (Block 432) the RSS engine 172 may identify and count the ad impression bids made by the winning brand (Block 440), the bid prices offered by the winning brand (Block 444), and the unique users bid on by the winning brand (Block 446). Similarly, for each on-winning brand (Block 432) the RSS engine 172 may identify and count the ad impression bids made by the non-winning brand (Block 450), the bid prices offered by the non-winning brand (Block 454), and the unique users bid on by the non-winning brand (Block 456). At Block 460, the RSS engine 172 of the publisher server 170 may store the brand metrics summed at Blocks 420, 424, 426, 440, 444, 446, 450, 454, and/or 456 to the publishing database 174.

Continuing to refer to flowchart 230 at Block 412, the brand metric collection function may be repeated for each bidding event by a brand that is retrieved from the exchange server 150. If no bid records for any brands remain unprocessed (Block 412), the brand metric collection function 230 may terminate at Block 415 and process control may return to Block 240 as illustrated in FIG. 2. Those of ordinary skill in the art will realize that the above embodiment of the present invention is only illustrative and is not intended to be limiting in any way. Other embodiments of algorithms for capturing pertinent brand metrics will readily suggest themselves to such skilled persons having the benefit of this disclosure.

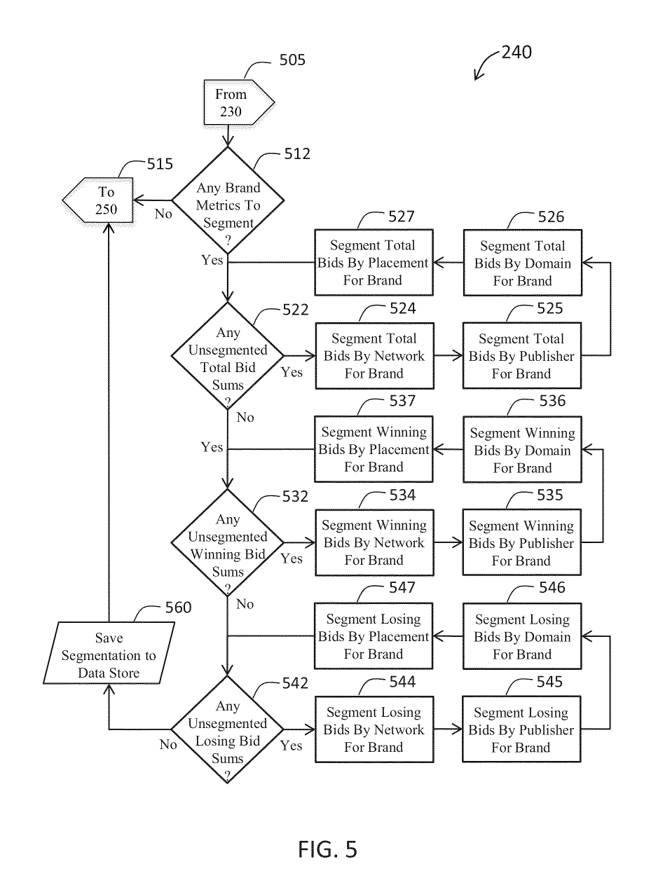

Referring now to flowchart 240 of FIG. 5 and continuing to refer to the block diagram of FIG. 1, the operation of the brand metric segmentation function of the RSS will be discussed in greater detail.

From the start, the operation may begin at Block 505. The brand metrics collected and stored to the publishing database 174 (as illustrated at Block 460 of FIG. 4) may be searched to identify any brand metric record that has not been further categorized by one or more segments of the publisher inventory to which the targeted ad impression belong (Block 512). For example, and without limitation, each brand metric record in the publishing database 174 may be processed to segment the parent bid event as demonstrating brand interest across network inventory, publisher inventory, domain inventory, and/or single placement inventory.

For example, and without limitation, the RSS engine 172 may identify each sum of total bids stored to the publishing database 174 (Block 522), and may further segment that sum of total bids by network inventory (Block 524), by publisher inventory (Block 525), by domain inventory (Block 526), and/or by inventory of a single placement (Block 527). Also for example, and without limitation, for each sum of total bids for a winning brand stored to the publishing database 174 (Block 532), the RSS engine 172 may further segment that sum of total bids for the winning brand by network inventory (Block 534), by publisher inventory (Block 535), by domain inventory (Block 536), and/or by inventory of a single placement (Block 537). Similarly, for each sum of total bids for a non-winning brand stored to the publishing database 174 (Block 542), the RSS engine 172 may further segment that sum of total bids for the non-winning brand by network inventory (Block 544), by publisher inventory (Block 545), by domain inventory (Block 546), and/or by inventory of a single placement (Block 547). At Block 560, the RSS engine 172 of the publisher server 170 may store the brand metric segmentation results from Blocks 524, 525, 526, 527, 534, 535, 536, 537, 544, 545, 546, and/or 547 to the publishing database 174.

Continuing to refer to flowchart 240 at Blocks 522, 532, and 542, the brand metric segmentation function may be repeated for each brand metric record present in the publishing database 174. If no records for any brand metrics in the publishing database 174 remain unprocessed (Blocks 522, 532, and 542), the brand metric segmentation function 240 may terminate at Block 515 and process control may return to Block 250 as illustrated in FIG. 2. Those of ordinary skill in the art will realize that the above embodiment of the present invention is only illustrative and is not intended to be limiting in any way. Other embodiments of algorithms for capturing pertinent brand metrics will readily suggest themselves to such skilled persons having the benefit of this disclosure.

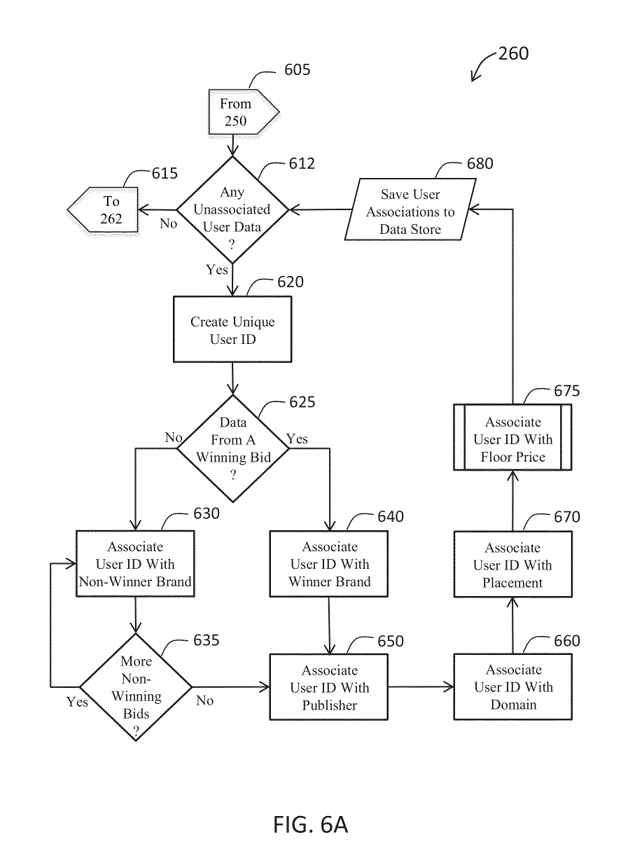

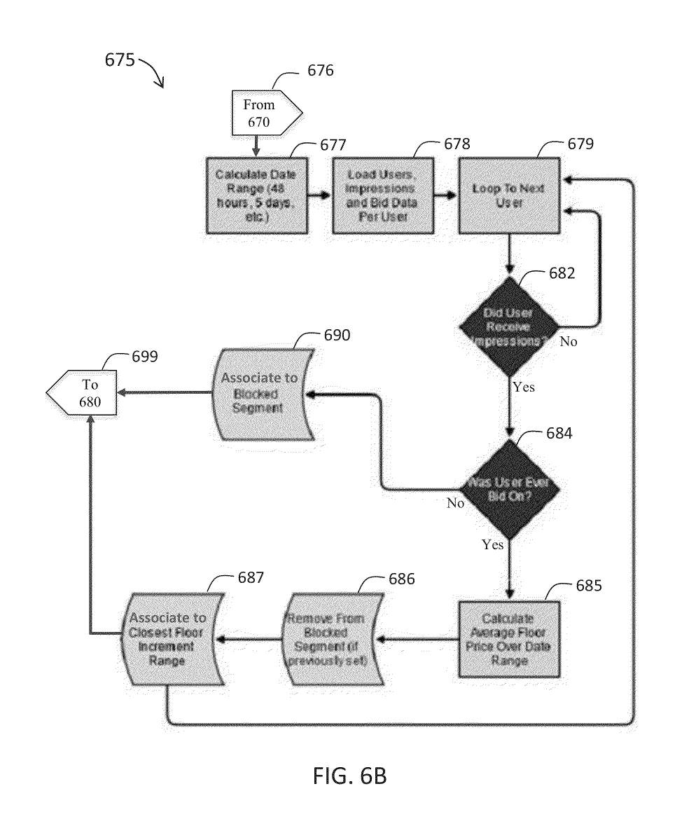

Referring now to flowchart 260 of FIG. 6A and continuing to refer to the block diagram of FIG. 1, the operation of the user-to-segment association function of the RSS will be discussed in greater detail.

From the start of the operation (Block 605), records created from billing information captured during any number of bidding events on the exchange server 150 (as illustrated at Block 250 of FIG. 2) may be parsed to identify each user to whom a targeted ad impression was delivered. For each targeted user for which data is present in the record, a datum may be processed that may associate the user with a brand metric segment stored to the publishing database 174 (as illustrated at Block 560 of FIG. 5). The parsed user data may be searched to identify any user data that the RSS engine 172 has not associated to the brand that bid on the user and to the inventory to which the target ad impression delivered to the user belongs.

For example, and without limitation, the RSS engine 172 may create and store a unique identifier for the user present in the record (Block 620). If the user data from the report stems from a winning bid event (Block 625), then the unique user ID may be associated with the winning brand (Block 640). If the user data stems from a non-winning bid event (Block 625), then the unique user ID may be associated with the non-winning brand (Block 630). Identification and association for non-winning brands may be accomplished for any number of non-winners who may have participated in the RTB auction (Blocks 630, 635). Whether stemming from a winning bid event or a non-winning bid event, the RSS engine 172 may further associate each unique user ID to the publisher (Block 650), the domain (Block 660), and the placement (Block 670) parsed from the billing information.

In another embodiment, as illustrated in flowchart 675 of FIG. 6B, the unique user ID may be associated with specific bid factors parsed from the record. In one embodiment of segmenting by bid factor, the RSS engine 172 may identify each user to whom impressions were delivered (Block 682) and may associate each corresponding unique user ID (Blocks 678 and 679) to an appropriate price floor increment parsed from the bid request information. For example, and without limitation, the RSS engine 172 may calculate an average floor price bid by a brand for a particular user over a range of dates (Blocks 677 and 685). The RSS engine 172 then may associate the unique user ID to the closest floor increment to the average floor price for that user (Block 687). In another embodiment of segmenting by bid factor, the RSS engine 172 may associate a unique user ID with a bid block. For example, and without limitation, the RSS engine 172 may recognize the special case of a particular user never being bid upon by any brands (Block 684), and may respond by associating that unique user id with a segment that blocks the user from future marketing efforts (Block 690). Such blocking may prevent wasteful expenditure of publisher resources on ad impression inventory that stands little chance of generating revenue. If a previously blocked unique user id subsequently experiences bidding attention, the RSS engine 172 may update the publishing database 174 to remove the unique userid from the blocked segment (Block 686).

At Block 699, the RSS engine 172 of the publisher server 170 may return control to Block 680 at FIG. 6A for storing of the user-to-segment association results from Blocks 620, 630, 640, 650, 660, 670, 687, and/or 690 to the publishing database 174. Continuing to refer to flowchart 260, the user-to-segment association function may be repeated for all user data present in the publishing database 174. If no user data remain unassociated at Block 612, the user-to-segment association function 260 may terminate at Block 615 and process control may return to Block 262 as illustrated in FIG. 2. Those of ordinary skill in the art will realize that the above embodiment of the present invention is only illustrative and is not intended to be limiting in any way. Other embodiments of algorithms for capturing pertinent user data will readily suggest themselves to such skilled persons having the benefit of this disclosure.

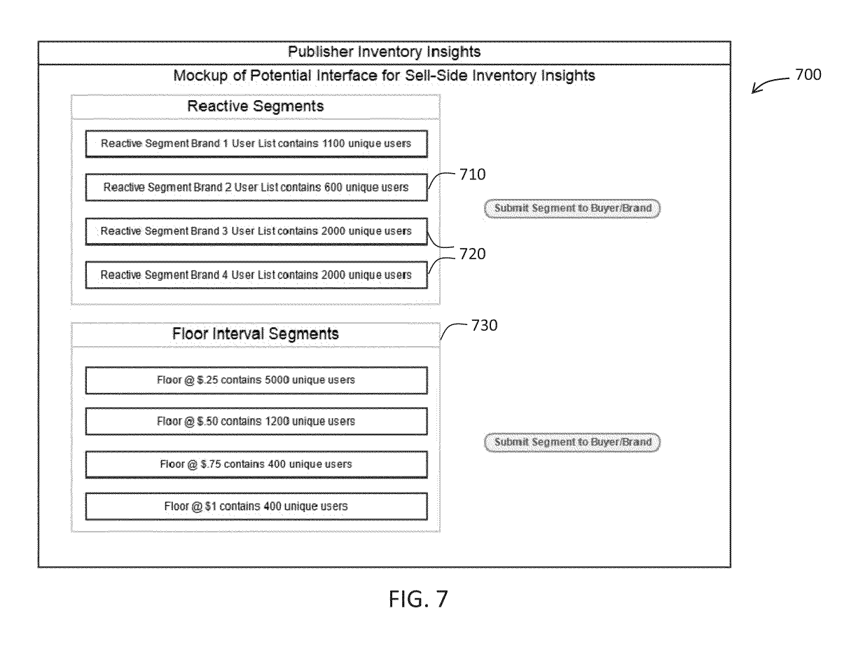

Referring now to the exemplary graphical user interface 700 of FIG. 7, the operation and display of the RSS for use by a publisher will be discussed in greater detail. More specifically, the relationship between the publisher server 170, the publisher workstation 180, and the operational steps of displaying and manipulating data organized by reactive segmenting will now be discussed. The following illustrative embodiment is included to provide clarity for one operational method that may be included within the scope of the present invention. A person of skill in the art will appreciate additional databases and operations that may be included within the RSS of the present invention, which are intended to be included herein and without limitation.

In one embodiment, the system interface 182 on the publisher workstation 180 may comprise a publisher dashboard 700 of reports and analysis tools. For example, and without limitation, the system interface 182 may be used to specify a date range of segmented data to display. Operational features such as sorting may present the segmented data in a meaningful way to advantageously support decision-making. For example, and without limitation, a publisher may use the system interface 182 to select brand metrics of interest, such as brands that are bidding the most but not winning RTB auctions 710, or brands that are bidding on the most unique users 720. Analysis of such information may equip the publisher to advantageously identify untapped revenue opportunities with brands that may subsequently be solicited for business outside of the RTB auction procedural limits. Alternatively, or in addition, analysis of segmented brand metrics, such as price floor intervals, may provide insights into the value 730 of a given ad impression (targeted user) that may help the publisher choose a custom bid price for a future auction and/or direct sale of similar ad impressions in the publisher inventory.

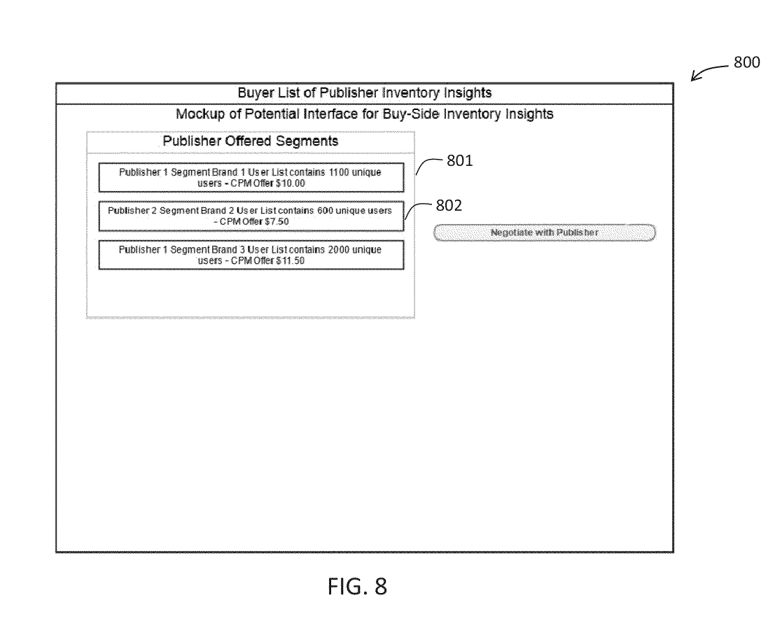

Referring now to the exemplary graphical user interface 800 of FIG. 8, the operation and display of the RSS for use by an advertiser will be discussed in greater detail. More specifically, the relationship between the publisher server 170, the advertiser workstation 130, and the operational steps of displaying and manipulating data organized by reactive segmenting will now be discussed. The following illustrative embodiment is included to provide clarity for one operational method that may be included within the scope of the present invention. A person of skill in the art will appreciate additional databases and operations that may be included within the RSS of the present invention, which are intended to be included herein and without limitation.

In one embodiment, the system interface 132 on the advertiser workstation 130 may comprise a display 800 of reports and interaction tools. For example, and without limitation, the system interface 132 may be used to display segmented data made available from publisher inventory 801. Operational features, such as search capability, may present the segmented data in a meaningful way to advantageously support identification of available ad impressions in publisher inventory. For example, and without limitation, an advertiser may use the system interface 132 to search segments of users available in the RTB marketplace 802. Analysis of such information may equip the advertiser to advantageously build an ad campaign based on known inventory segments rather than on untested, self-defined target market requirements. Alternatively, or in addition, search of available segments may provide insights into direct buy opportunities that may not be available through the RTB auction process.

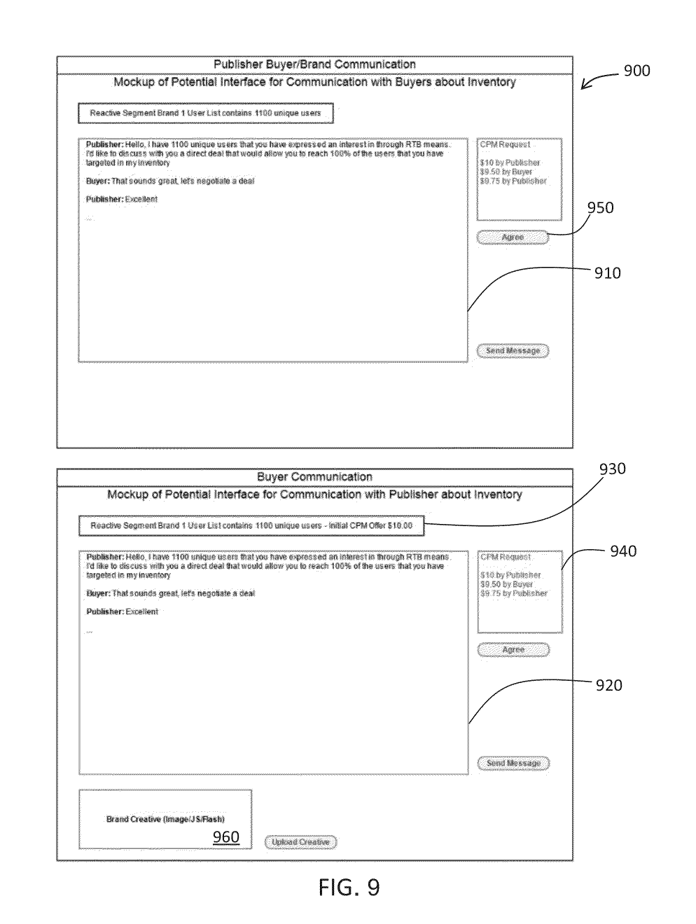

Referring now to the exemplary graphical user interfaces 900 and 902 of FIGS. 9A and 9B, respectively, the operation and display of the RSS to facilitate direct negotiation between a publisher and an advertiser will be discussed in greater detail. More specifically, the relationship between the publisher server 170, the publisher workstation 180, the advertiser workstation 130, and the operational steps of negotiating ad placement based on the reactive segmenting model will now be discussed. The following illustrative embodiment is included to provide clarity for one operational method that may be included within the scope of the present invention. A person of skill in the art will appreciate additional databases and operations that may be included within the RSS of the present invention, which are intended to be included herein and without limitation.

In one embodiment, a publisher and an advertiser may use their respective RSS clients 184, 136 to directly negotiate a direct buy of ad inventory outside of the RTB auction paradigm. For example, and without limitation, such forms of direct buy may include deal ID/private marketplaces, programmatic direct, and programmatic forward. Automated execution of such a contract to start publisher servicing of a brand's ad campaign may be referred to as signing a digital insertion order (10). For example, and without limitation, the system interface 182 on the publisher workstation 180 may comprise a messaging field 910 and the system interface 132 on the advertiser workstation 130 may comprise a complementary messaging field 920. After a search of available segmented inventory allows the advertiser to identity a desired ad impression 930, a buyer for the advertiser may contact the publisher by message to make a price offer for the ad impression 940. The publisher may respond to the advertiser by message with an acceptance of the offer 950, a rejection of the offer, or a counteroffer. If the negotiation between the publisher and the advertiser results in mutual acceptance of a price for the ad impression that may not be up for RTB auction but is nonetheless in publisher inventory, the RSS engine 170 may electronically process the consideration for the transaction and trigger the ad to be served 960.

A person of skill in the art will appreciate that the direct negotiation capability described above may similarly support direct negotiation between a publisher and more than one advertiser concurrently (e.g., brand negotiation). Buyers for multiple advertisers may contact the publisher by message to submit their competing price offers for an ad impression. The publisher may respond to one or more advertisers in the brand by message with an acceptance, a rejection, or a counteroffer to one or more competing offers. If the negotiation between the publisher and the brand results in mutual acceptance, the RSS engine 170 may electronically process the consideration for the transaction and trigger the ad to be served.

The system capabilities described above advantageously may support a) automation of ad delivery by RTB auction, b) automation of direct purchase of ad delivery based on segmented data, and c) automatic loading of house ads in lieu of blocked segments.

Embodiments of the present invention are described herein in the context of a system of computers, servers, and software. Those of ordinary skill in the art will realize that the embodiments of the present invention described above are provided as examples, and are not intended to be limiting in any way. Other embodiments of the present invention will readily suggest themselves to such skilled persons having the benefit of this disclosure.

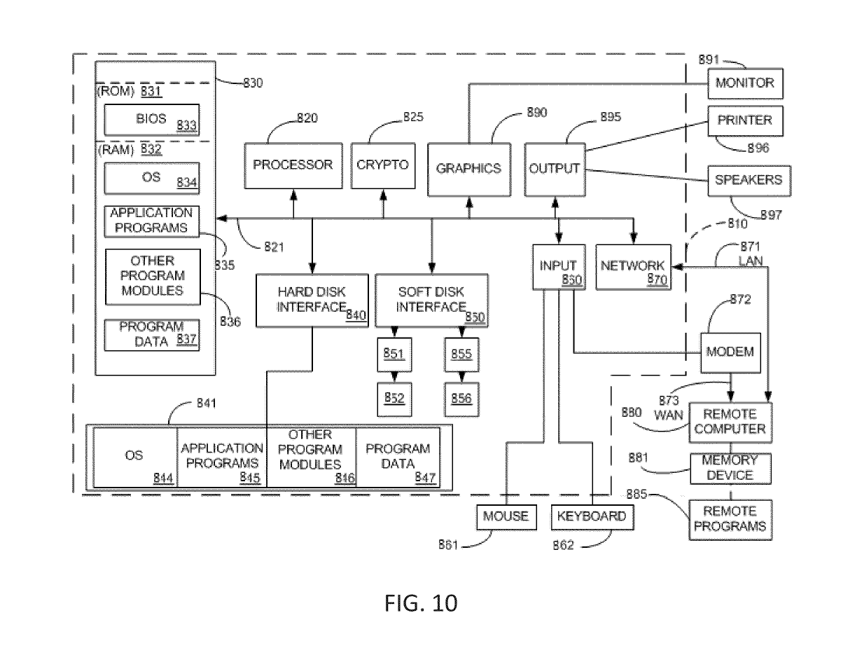

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 10 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates an operating system (OS) 834, application programs 835, other program modules 836, and program data 837.

The computer 810 may also include other removable/non-removable, volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 10, provide storage of computer readable instructions, data structures, program modules and other data for the computer 810. In FIG. 10, for example, hard disk drive 841 is illustrated as storing an OS 844, application programs 845, other program modules 846, and program data 847. Note that these components can either be the same as or different from OS 833, application programs 833, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 10. The logical connections depicted in FIG. 10 include a local area network (LAN) 871 and a wide area network (WAN) 873, but may also include other networks 140. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A computer implemented method of reactive segmenting for providing decision support for marketing of online advertising, comprising:
receiving bid information comprising real-time bidding (RTB) event data for a targeted ad impression, wherein the targeted ad impression is one of a plurality of ad impressions defining a publisher inventory;
creating, using the bid information, a plurality of bid records each comprising an ad impression identifier, a bid price, and a bidder identifier,
wherein the bidder identifiers in the plurality of bid records collectively identify a plurality of advertisers defined as a brand, and
wherein the plurality of advertisers includes a winning bidder and a non-winning bidder; and
analyzing the plurality of bid records to determine a demand from the brand for the publisher inventory other than the targeted ad impression.

2. The method according to claim 1 wherein analyzing the plurality of bid records further comprises determining a targeted user of interest to a brand segment selected from the group consisting of the winning bidder, the non-winning bidder, and the plurality of advertisers; and further comprising associating the targeted user to the brand segment.

3. The method according to claim 2 wherein analyzing the plurality of bid records further comprises determining an inventory segment for the targeted ad impression, the inventory segment selected from the group consisting of network inventory, publisher inventory, domain inventory, and single placement inventory; and
further comprising associating the targeted user with the inventory segment.

4. The method according to claim 3 wherein analyzing the plurality of bid records further comprises determining a bid factor for the targeted ad impression, the bid factor selected from the group consisting of an average price floor, a price floor increment, and a bid block condition; and further comprising associating the targeted user to the bid factor.

5. The method according to claim 1 wherein analyzing the plurality of bid records further comprises determining at least one bid price for the targeted ad impression received from one or more of the winning bidder, the non-winning bidder, and the brand.

6. The method according to claim 1 wherein analyzing the plurality of bid records further comprises determining at least one count of bids received for the targeted ad impression from one or more of the winning bidder, the non-winning bidder, and the brand.

7. The method according to claim 6 wherein analyzing the plurality of bid records further comprises determining an inventory segment for the targeted ad impression, the inventory segment selected from the group consisting of network inventory, publisher inventory, domain inventory, and single placement inventory; and
further comprising associating the at least one count of bids with the inventory segment.

8. The method according to claim 6 wherein analyzing the plurality of bid records further comprises determining for the inventory segment at least one count of bids received for the targeted ad impression, wherein the at least one count of bids is received from one or more of the winning bidder, the non-winning bidder, and the brand.

9. The method according to claim 1 further comprising identifying a marketing target based on the demand from the brand.

10. The method according to claim 1 further comprising setting at least one of a price and a price floor for one of the publisher inventory other than the targeted ad impression based on the demand from the brand.

11. A computer system defining a reactive segmenting system for providing decision support for marketing of online advertising, the system comprising at least one publisher server configured to:
retrieve, from an ad network, bid information comprising real-time bidding (RTB) event data for a targeted ad impression, wherein the targeted ad impression is one of a plurality of ad impressions defining a publisher inventory;
create, using the bid information, a plurality of bid records each comprising an ad impression identifier, a bid price, and a bidder identifier,
wherein the bidder identifiers in the plurality of bid records collectively identify a plurality of advertisers defined as a brand, and
wherein the plurality of advertisers included in the brand includes a winning bidder and a non-winning bidder; and
analyze the plurality of bid records to determine a demand from the brand for the publisher inventory other than the targeted ad impression.

12. The computer system according to claim 11 wherein the at least one publisher server is further configured to analyze the plurality of bid records by
determining a targeted user of interest to a brand segment selected from the group consisting of the winning bidder, the non-winning bidder, and the plurality of advertisers included in the brand; and
associating the targeted user to the brand segment.

13. The computer system according to claim 12 wherein the at least one publisher server is further configured to analyze the plurality of bid records by
determining an inventory segment for the targeted ad impression, the inventory segment selected from the group consisting of network inventory, publisher inventory, domain inventory, and single placement inventory; and
associating the targeted user with the inventory segment.

14. The computer system according to claim 13 wherein the at least one publisher server is further configured to analyze the plurality of bid records by
determining a bid factor for the targeted ad impression, the bid factor selected from the group consisting of an average price floor, a price floor increment, and a bid block condition; and
associating the targeted user to the bid factor.

15. The computer system according to claim 11 wherein the at least one publisher server is further configured to analyze the plurality of bid records by determining at least one bid price for the targeted ad impression received from one or more of the winning bidder, the non-winning bidder, and the brand.

16. The computer system according to claim 11 wherein the at least one publisher server is further configured to analyze the plurality of bid records by determining at least one count of bids received for the targeted ad impression from one or more of the winning bidder, the non-winning bidder, and the brand.

17. The computer system according to claim 16 wherein the at least one publisher server is further configured to analyze the plurality of bid records by
determining an inventory segment for the targeted ad impression, the inventory segment selected from the group consisting of network inventory, publisher inventory, domain inventory, and single placement inventory; and
associating the at least one count of bids with the inventory segment.

18. The computer system according to claim 16 wherein the at least one publisher server is further configured to analyze the plurality of bid records by determining for the inventory segment at least one count of bids received for the targeted ad impression, wherein the at least one count of bids is received from one or more of the winning bidder, the non-winning bidder, and the brand.

19. The computer system according to claim 11 wherein the at least one publisher server is further configured to identify a marketing target based on the demand from the brand.

20. The computer system according to claim 11 wherein the at least one publisher server is further configured to set at least one of a price and a price floor for one of the publisher inventory other than the targeted ad impression based on the demand from the brand.

21. A computer system defining a reactive segmenting system for providing decision support for marketing of online advertising, the system comprising at least one publisher server, an ad network, and a publisher workstation interconnected by a data network;
the at least one publisher server comprising a publisher database, and configured to:
identify a targeted ad impression defined as one of a plurality of ad impressions stored in the publisher database, wherein the plurality of ad impressions defines a publisher inventory,
retrieve, from the ad network, bid information comprising real-time bidding (RTB) event data for the targeted ad impression,
create, using the bid information, a plurality of bid records each comprising an ad impression identifier, a bid price, and a bidder identifier, wherein the bidder identifiers in the plurality of bid records collectively identify a plurality of advertisers defined as a brand, and wherein the plurality of advertisers included in the brand includes a winning bidder and a non-winning bidder,
create, using the plurality of bid records, segmented data, and
store the plurality of bid records and the segmented data to the publisher database; and
the publisher workstation comprising a system interface, and configured to:
search, using the publisher database, the plurality of bid records and the segmented data, and
display, using the system interface, a demand from the brand for the publisher inventory other than the targeted ad impression, wherein the demand is defined, in part, by the plurality of bid records and the segmented data.

22. The computer system according to claim 21 wherein
the at least one publisher server is further configured to
create, using the plurality of bid records and the segmented data, user-to-segment association data, and
store the user-to-segment association data to the publisher database; and wherein
the publisher workstation is further configured to
search, using the publisher database, the user-to-segment association data, and
display, using the system interface, the demand from the brand for the publisher inventory other than the targeted ad impression, wherein the demand is further defined, in part, by the user-to-segment association data.

23. The computer system according to claim 21 wherein the publisher workstation is further configured to support direct sale of the publisher inventory other than the targeted ad impression to the non-winning bidder.
